(19) United States
(12) Patent Application Publication
(10) Pub. No.: US 2017/0214880 A1
(43) Pub. Date: Jul. 27, 2017

(54) METHOD FOR HELPING A PERSON TO SELECT A FURNISHING COVERING SURFACE

(71) Applicant: MATICAD S.R.L., I-61122 PESARO (IT)

(72) Inventors: FRANCO AMPOLLINI, PESARO (IT); MASSIMO ROSSINI, PESARO (IT); ALESSANDRO BEVILACQUA, BOLOGNA (IT); ALESSANDRO GHERARDI, PIANORO (IT)

(21) Appl. No.: 15/328,603

(22) PCT Filed: Jul. 15, 2015
(86) PCT No.: PCT/IB2015/055350

§ 371 Date: Jan. 24, 2017

(30) Foreign Application Priority Data
Jul. 30, 2014 (IT) BO2014A000431

(51) Int. Cl. H04N 5/445; G06K 9/62; H04N 5/232; G06T 7/70; G06T 7/11

(52) U.S. Cl. CPC H04N 5/44504; G06T 7/70; G06T 7/11; H04N 5/44543; H04N 5/23293; G06K 9/6267; G06T 2207/30244; G06T 2207/10028; G06T 2200/04; G06T 2200/24; G06T 2210/04

(57) ABSTRACT

Described is a method for helping a person to select a furnishing covering surface, comprising the following steps: self-localizing without markers an image acquisition device 2, for determining a pose of the image acquisition device 2; identifying, in at least one image acquired by the image acquisition device 2, a portion of image corresponding to a pre-existing surface to be substituted; segmenting, in one or more images acquired by the image acquisition device 2, at least the portion of image identified; selecting, using a menu displayed on a display 5, a type of furnishing covering surface with which to replace the portion of image previously identified; generating at least one image in which the portion of image is substituted with the type of furnishing covering surface previously selected.

### TECHNICAL FIELD

This invention relates to a method for helping a person to select a furnishing covering surface.

This invention also relates to a mobile device programmed to perform the method. This invention also relates to a computer program comprising a software configured for executing the steps of the method if launched on the device.

### BACKGROUND ART

This invention falls within the context of virtual reality and in particular in that of Augmented Reality systems (AR), which allow an image to be modified by introducing objects, modifying elements present, and/or displaying information on the image.

More specifically, this method falls within the context of augmented reality applications for interior design. This method also finds applications in the cultural heritage and architectural sectors.

The prior art methods allow modifications to be made or information and elements to be added of any type, for example objects, surfaces, text. The image of the actual room may be acquired by a normal digital camera and the additional information, for example virtual objects, may be inserted in the digital image in accordance with the perspective characteristics and the luminosity conditions of the actual room.

The prior art also comprises AR systems and methods for the presentation of products. For example, AR applications are known which allow the user to display digital images of furnishing elements, inserted in the digital image of the actual room in which the furnishing element is to be placed. In this way, it is possible for the user to visually perceive the appearance which a potential purchase will have inside a particular room.

For example, before covering the floor or changing the colour of the walls of a room, it may be particularly useful to visually perceive the final result by applying these modifications in advance in a virtual room (that is, in a digital representation). Using a database containing a predetermined number of possible options, the user can explore various possibilities and display the result of the modifications quickly, and before making a purchase.

However, the AR applications of the sector which are currently available are limited to the addition of information relating to objects not present in the original room, for example by inserting new objects in the original image. On the contrary, the aim of the solution presented here is to modify the appearance of elements already included in the original image and subsequently identified (for example, by selection by the user).

The final result of the process must be an attractive and credible representation of the modified real room; in other words, the covering of the existing floor, the colour or the texture of the walls and the surfaces modified must be consistent with the point of view of the user, in such a way as to retain the correct perspective view of the scene. To achieve this it is necessary to know the position and the orientation in space (that is, the pose) of the image acquisition device.

The substitution of an element of a digital representation presupposes knowledge of the perspective; thus, the substitution is the virtual equivalent (in terms of processing of images) of a physical substitution of one element with another: this effect cannot be obtained by photo retouching, precisely due to the need to know and control the perspective of the element.

For this purpose, algorithms are necessary for segmenting the image and assessing the pose of the image acquisition device. Despite the fact that segmenting images is a subject widely dealt with in the prior art and in the literature, in a general context, the automatic segmenting of images still remains an unresolved problem.

Moreover, in order to modify the elements present in the digital representation whilst maintaining the view point and the correct perspective view, the intrinsic parameters (for example, focal length, main point and distortion coefficients) of the image acquisition device must be known in advance or calculated by means of calibration algorithms of the camera.

Known in the prior art, for example from patent documents US2010/0289817A1 and US2010/0287511A1, are techniques which modify the digital image using segmenting algorithms, for example to add new elements in a digital representation of a room. These algorithms are also used for removing or hiding at least part of the digital representation of the pre-existing elements, which may be hidden by new elements inserted in the image.

In these patent documents, the segmenting is performed for removing objects from the digital representation of a room in such a way as to insert new elements, such as for example virtual furnishing elements, or for moving these objects to free space to insert the new elements.

However, these techniques do not provide an effective help for selecting a furnishing covering surface (for example, a floor or a wall).

Moreover, a limitation of the prior art solutions is linked to the fact that the image to be acquired may have various luminance conditions. Moreover, the surfaces represented in it may have various surface appearances, with more or less complex textures or designs.

In light of this, the prior art solutions do not allow the segmenting step to be adapted, in a simple and effective manner, to the various features and conditions of brightness that the portion of the image to be segmented may have. In other words, the application of a particular segmenting algorithm produces results which are more or less satisfactory depending on the characteristics of the single room to be captured; with the changing in the features of the room, the prior art solutions do not guarantee an automatic segmenting which is able to precisely identify the pixels belonging to the floor and/or to the surfaces of the walls.

Another technical solution is described in patent document DE102007045835A1, regarding a software in the field of augmented reality. In particular, DE102007045835A1 regards a software for shifting an object inside the scene, or for adding a new object to an image taken by a camera; in the first case, the image portion left empty by the removed object is filled with an image portion having the same texture and visual characteristics as the image portion surrounding the removed object, in order to provide the visual effect of rendering invisible the object in the image taken by the camera, whereby the objects positioned behind the object to be removed were not visible in the taken image but become visible in the modified image. However, this document does not provide any help for a person who has to choose a furnishing covering surface.

### Aim of the Invention

The aim of this invention is to provide a method for helping a person to select a furnishing covering surface which overcomes the above-mentioned drawbacks of the prior art.

More specifically, the aim of this invention is to provide a method for helping a person to select a furnishing covering surface which allows the user to display in real time an image of the room where there is the surface in question (that is, the pre-existing surface), and in which the covering of this surface is the one selected from a catalogue, instead of the actual one present in the room. In other words, the aim of this invention is to provide a method for helping a person to select a furnishing covering surface which allows the substitution of a digital representation of a pre-existing furnishing covering surface with a digital representation of a new furnishing covering surface, selected by the user. Preferably, the substitution occurs by superimposing and the digital representation of the new furnishing covering surface is also defined as “superimposed surface”.

A further aim of this invention is to propose a method for helping a person to select a furnishing covering surface which is particularly precise with variations in the features of the pre-existing surface.

A further aim of this invention is to propose a method for helping a person to select a furnishing covering surface which is particularly simple and easy to use.

Another aim of this invention is to provide a mobile device programmed for helping a person to select a furnishing covering surface.

Another aim of this invention is to provide a computer program comprising a software for helping a person to select a furnishing covering surface. It should be noted that the software can define a tablet or smartphone application.

These aims are fully achieved by the device according to this invention as characterised in the appended claims.

More specifically, the invention relates to a method and a device for helping a person to select a furnishing covering surface.

The method according to this invention comprises the following steps:
self-localizing without markers an image acquisition device, for determining a pose of the image acquisition device;
identifying, in at least one image acquired by the image acquisition device, of a portion of image corresponding to a pre-existing surface to be substituted;
segmenting, in one or more images acquired by the image acquisition device, at least said portion of image identified;
selecting, using a menu displayed on a display, a type of furnishing covering surface with which to replace said portion of image previously identified;
generating at least one image in which said portion of image is substituted with the type of furnishing covering surface previously selected.

In one embodiment of the present disclosure, said menu comprises a plurality of types of furnishing covering surface (such as a floor, wall, or other covering surfaces). The types of furnishing covering surface included in the menu are predefined, and therefore they are not responsive to or derived from the texture features of the acquired image.

In the generating step, the image portion is substituted with a new image portion having features which are responsive to or determined by the type of furnishing covering surface previously selected and are independent with and unrelated to the texture features of the image part surrounding the substituted portion. According to an embodiment, the image portion is substituted by overimpression, that is, it is overimpressed.

The new image portion replacing the image portion to be substituted is visually distinct and well identifiable, with respect to the remaining portion of the image. The new image portion replacing the image portion to be substituted has a visual and/or semantic coherence as a visual object, when taken by itself.

In addition, the image portion to be substituted has a first perspective property and the new image portion substituted thereto has a perspective property which is the same or corresponding to that of the substituted image portion; and/or the new image portion substituted thereto has a perspective property which is compliant with the scene defined by the image.

According to one aspect of this description, the method allows the modification, in real time, of the appearance of the floor and/or walls of a room, acquiring an image using an image acquisition device, identifying at least a portion of image corresponding to a pre-existing surface and modifying the appearance, preferably by superimposing a new furnishing covering surface.

Preferably, the modifications applied to the image are rendered graphically in accordance with the perspective characteristics, in such a way that the user has difficulty in perceiving inconsistencies with the parts of the image which have not been modified.

If necessary, the self-localizing step is preceded by a calibrating procedure, carried out (preferably only once) for estimating the intrinsic parameters (that is, calibration parameters) of the image acquisition device.

The intrinsic parameters of the image acquisition device, necessary to correctly render the modified image of the room, may be calculated off-line during calibration, according to prior art methods, or by a self-calibrating procedure which requires multiple views of the same room (using prior art techniques, such as for example the “absolute cone” technique), or by extracting the vanishing points from a single image (according to further prior art techniques).

The self-localizing step allows the determining of the pose of the image acquisition device, that is to say, its extrinsic parameters. It should be noted that in this description, the expression “determining of the pose” means the determining, by a computer connected to the image acquisition device, of the parameters which allow the perspective of the image acquired to be known, more specifically, the orientation of the acquisition device and at least a position coordinate in a 3D reference system.

Preferably, the position coordinate coincides with the distance of the camera from the ground (that is, from the plane defined with the floor). Preferably, the distance of the camera from the ground has a preset value, contained in a memory connected to the computer and to the image acquisition device; preferably, this preset value lies within the range of [1-2] metres, more preferably within the range of [1.30-1.60] metres; more preferably this value is equal to approximately 1.45 metres.

The orientation of the image acquisition device may be estimated directly from the image acquired, by determining the vanishing points by the computer.

Preferably, the self-localizing step comprises the use of data coming from one or more motion sensors. Preferably, the one or more motion sensors comprise inertial and/or magnetic sensors (for example, an accelerometer and a magnetometer). The correlation of this data with the features of the image acquired improves the determining of the orientation of the image acquisition device in space. In another embodiment of this invention, the determining of the perspective view can be further improved by using, alongside the data coming from the accelerometer and from the magnetometer, data coming from a gyroscope.

It should be noted that modern mobile devices, such as smartphones and tablets, are generally equipped with an image acquisition device, motion sensors, a computer and a memory.

According to another aspect of the invention, it is possible to perform the self-localizing of the image acquisition device by means of a plurality of images containing superimposed portions of the same scene acquired from different points of view; this is performed by means of a process known in the prior art (Simultaneous Localization and Mapping—SLAM) which allows both the 3D reconstruction of the surrounding room and the estimation of the pose of the acquisition device.

In effect, it should be noted that the self-localizing can occur in various ways. For example, using a single image, if there is a sufficient number of perspective elements (vanishing points and lines, etc.); or, using an image and magnetic/inertia sensors (to improve estimation); or, using a plurality of images of the scene acquired from different points and partly superimposed in a process which generates both a 3D reconstruction of the room and the estimation of the pose (self-localizing).

According to the method according to this invention, the image acquisition device acquires images of a room either individually or in streaming (video clips); the image acquisition device is connected to a calculator which calculates in real time a reference system, which is maintained during the acquisition, which means that the images are stored in a memory together with data relating to the reference system; this allows data relating to a perspective view of the elements of the image to be associated with each image. This perspective data is necessary to graphically render, in a particularly accurate and credible manner, a digital representation of an element substituting a pre-existing one.

During the self-localizing step, the data coming from the inertial sensor, measured in real time, is correlated with data coming from the image acquisition device, which is also measured in real time, detecting salient features of the image which act as a reference also for correlating images detected at successive points in time (in effect, successive images are not identical, but are partly superimposed).

In this invention, an augmented reality system acts on the image of an actual room modifying the appearance of one or more, preferably flat, furnishing covering surfaces. In one particular embodiment of this invention, it is possible to modify the floor and the walls of a room, entirely or only partly, in order to change the surface appearance, given for example by the colour, or the aesthetic appearance given by the covering, for example with wallpaper, tiles or parquet.

For this purpose, it is necessary to use a method which allows the elements of a room to be identified inside a relative digital representation. More specifically, this description refers to image processing algorithms included in the image segmenting sector.

In one particular embodiment, one or more segmenting algorithms are used to identify and group together (that is, segment), by semantic coherence, the pixels of the original image belonging to the floor and/or the walls of the room (that is to say, to the pre-existing surface to be substituted), without affecting other elements present in the scene.

After completion of the self-localizing step, and therefore when the extrinsic parameters of the image acquisition device are known, the method according to the invention comprises the step of identifying, in at least one image acquired by the image acquisition device, a portion of image corresponding to a pre-existing surface to be substituted. The segmenting process may be performed on the entire image to identify the larger surfaces.

According to one aspect of this invention, intervention of the user is allowed when the result of the segmenting is unsatisfactory. In this context, the intervention allowed by the user is aimed at the finishing by additional tools (for example virtual pencil, rubber) of the edges of the areas identified automatically by the segmenting algorithms. The indication of the characteristic point by the user is in any case performed beforehand (it is necessary for the 2D case and optional in the 3D case); after identifying this point, the classifier provides the class to which the surface belongs and this makes it possible to apply the algorithm or the algorithms most suitable for segmenting the surface indicated.

For example, the user can indicate a characteristic point on the image acquired, for example by touching the characteristic point on a touch-screen display connected to the image acquisition device, to facilitate the identification, by semantic coherence, of the pre-existing furnishing covering surface. When the result of an automatic segmenting is not satisfactory, the user is given the possibility to intervene manually, drawing or removing portions of the surfaces identified in the image.

In one particular embodiment of this invention, after performing the segmenting, an optional refining process is presented to the user, to be able to apply a refinement of the planar covering, for example by manual intervention, deleting segmented areas, selecting regions of images, and obtaining a representation of the covering which is more faithful to the reality.

A classifier programmed previously, for example a Random Forest or SVM classifier, identifies and classifies the features of the pre-existing surface. The features identify the category of furnishing covering surface to which the pre-existing surface belongs.

Preferably, there are at least three categories of covering surfaces. For example, one of these categories might consist of surfaces of uniform colour. Another category might comprise, for example, tiled surfaces in which the vanishing points between one tile and another are clearly visible. A third type might be non-uniform surfaces in which the representation of the texture of the covering is random or not uniform.

According to the results of the classification, a segmenting algorithm (that is, one or more algorithms) is selected from a series of possible algorithms designed to work on each of the surface categories identified in the identifying step.

The selecting step allows the user to select, preferably using a menu displayed on a display connected to the memory, to the computer and/or to the image acquisition device, amongst various types of furnishing coverings, to superimpose on the pre-existing surface. The aim of this invention is to provide the user with the possibility of selecting between a plurality of furnishing coverings, for applying the modifications to the image through an interface which is easy to use and displaying the modifications applied on the image in real time. The user can select between various types of furnishing coverings, for example tiles or parquet, selected from a database, to be superimposed on the portion of image identified.

Lastly, the method comprises the generation of at least one image in which the portion of image is substituted with the type of furnishing covering surface previously selected. In other words, an image is generated in which the pre-existing surface has been substituted, by superimposing, with the new furnishing covering surface selected previously. Moreover, the intensity of the lights present in the digital representation is maintained also in the portions of image modified.

The method according to this invention therefore allows the user to modify a digital representation of a real room using a mobile device equipped with an image acquisition device, a display, a memory and a computer. If necessary, the mobile device also comprises one or more motion sensors (for example, accelerometer, magnetometer, gyroscope).

The invention according to this invention comprises a software for processing the digital images, and in one particular embodiment uses a digital camera as an image acquisition device and a personal computer (PC) comprising a computer and a memory. It should be noted that, for displaying the images, the display may be connected to the image acquisition device and/or to the PC. In this particular embodiment, the image acquisition device acquires at least one image of the room which is then transmitted to a PC, for being processed according to the steps of the method according to this invention.

As regards the method according to this invention, attention is also drawn to the following.

The segmenting step is performed, preferably, in two dimensions (2D).

This simplifies the calculations whilst guaranteeing an accurate segmenting.

According to one aspect of this invention, the segmenting is performed in 3D; in this case, the identification of the flat surface to be segmented can be performed automatically by the software, without the action of selection by the user. In this context, it should be noted that, with the 3D segmenting, the planar surfaces can be more than one and the user has the possibility of indicating which new coverings to apply to the surfaces identified.

Preferably, the segmenting is in real time relative to the acquisition of the image; this allows the user to display on the display in real time, that is to say, whilst capturing the scene with the image acquisition device, the modified digital representation, wherein the pre-existing surface has been substituted by the superimposed surface.

In one embodiment, the method comprises acquiring (taking) a photo of the room and performing the segmenting on the image acquired; after selecting the furnishing covering surface desired by the user, the device returns to the user another image (preferably 2D) with the covering substituted.

Basically, in a embodiment according to this invention, the software requires the following inputs from the user:
which pre-existing surface is to be replaced and where this pre-existing surface is in the image;
with which another type of furnishing covering surface the pre-existing surface must be replaced (that is, superimposed).

Preferably, the segmenting step follows the identifying step, but not necessarily immediately after it.

Preferably, the selecting step is before the generating step, but not necessarily immediately before it.

The invention also provides a mobile device; the device comprises an image acquisition device, preferably calibrated, a memory, a computer and a display. Preferably, the mobile device also comprises one or more motion sensors (for example, accelerometer, magnetometer, gyroscope). The computer is programmed to perform one or more of the above-mentioned steps.

According to an embodiment, the portable device is a smartphone or a tablet, equipped with a digital camera, a processing unit and a display, preferably a touch screen. The portable device thereby integrates in a single device the acquisition and processing functions.

The invention also relates to a computer program comprising a software, that is, a code (adapted) for performing one or more of the steps described above, if (that is, when) run on the device mentioned above (for example, the tablet or the smartphone).

This invention also relates to a computer readable storage medium, comprising the above-mentioned computer program.

### BRIEF DESCRIPTION OF THE DRAWINGS

This and other features of the invention will become more apparent from the following detailed description of a preferred, non-limiting example embodiment of it, with reference to the accompanying drawings, in which:

FIG. 1 shows a schematic representation of the mobile device according to this invention;

FIG. 2 shows a schematic perspective view of an example of a room to which the method according to this invention can be applied;

FIG. 3 shows a schematic perspective view of a first example of identifying a pre-existing surface (floor);

FIG. 4 shows a schematic perspective view of a second example of identifying a pre-existing surface (wall);

FIG. 5 shows a schematic perspective view of the room of FIG. 3 with a furnishing covering surface superimposed on the pre-existing surface.

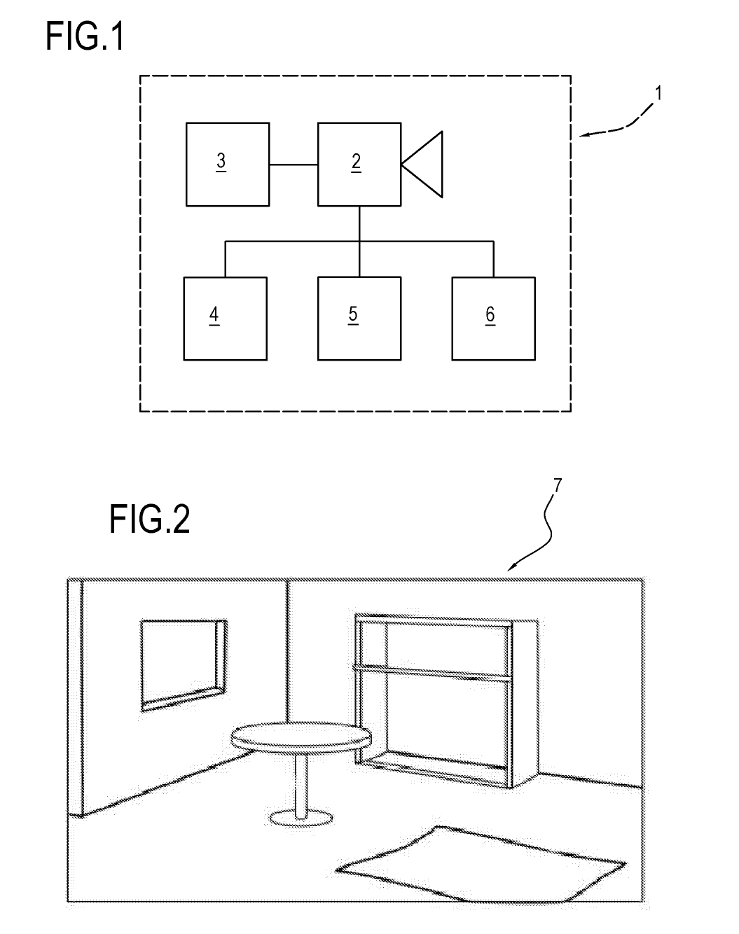

### DETAILED DESCRIPTION OF PREFERRED EMBODIMENTS OF THE INVENTION

With reference to the accompanying drawings, the numeral 1 denotes a mobile device designed for helping a person to select a furnishing covering surface. The mobile device 1 comprises an image acquisition device 2, preferably calibrated, to allow the acquisition of at least one image of a room 7. The mobile device 1 also comprises a display 5, for displaying in real time the image of the room 7. Preferably, the display 5 is of the touch-screen type, to allow the user to interact easily and quickly with the mobile device 1.

The mobile device 1 comprises a computer 6. The computer 6 determines the extrinsic parameters of the image acquisition device 2 using certain characteristics of the image acquired for calculation of the vanishing points.

In one particular embodiment, the mobile device 1 comprises one or more motion sensors 3 for assessing extrinsic parameters of the image acquisition device 2. More specifically, the one or more motion sensors 3 comprise inertial and/or magnetic sensors, such as, for example, an accelerometer, a magnetometer, a gyroscope.

In one particular embodiment, the extrinsic parameters are calculated by the computer 6, during a self-localizing step, using data coming from the accelerometer and from the magnetometer. In a further embodiment, the extrinsic parameters are calculated with greater precision by the computer 6, during a self-localizing step, using data coming from the accelerometer, from the magnetometer and from a gyroscope.

The determining of the extrinsic parameters occurs by means of simple trigonometric relations which require the knowledge of at least a position coordinate, in a 3D reference system, of the image acquisition device 2. Preferably, the position coordinate is equal to the distance of the image acquisition device 2 from the ground (that is, from the plane defined by the floor). Preferably, the distance of the camera from the ground has a preset value (but which can be modified as desired by the user), contained in the memory of the device; preferably, this preset value lies within the range of [1-2] metres, more preferably within the range of [1.30-1.60] metres; more preferably approximately 1.45 metres.

According to the method according to this invention, the image acquisition device 2 acquires images of a room 7 either individually or in streaming (video clips); the image acquisition device 2 sets up (in real time) a reference system, which is maintained during the acquisition, which means that the images are stored in a memory 4 together with metadata relating to the reference system; this allows data relating to a pose of the acquisition device to be associated with each image and therefore to obtain the perspective of the elements of the image.

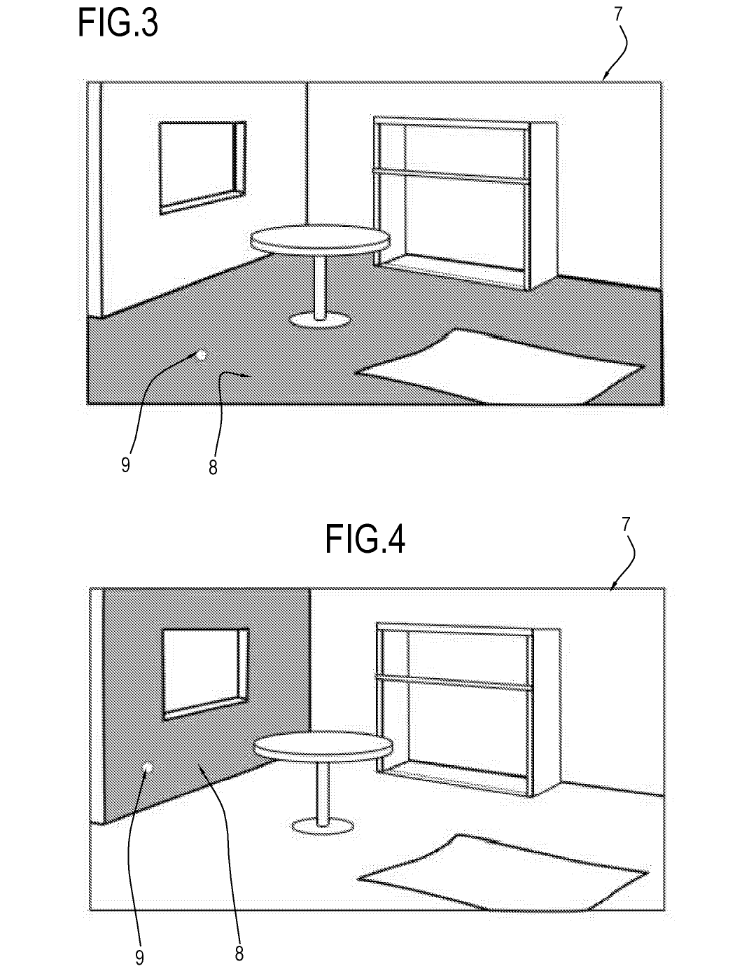

In this description, at least one segmenting algorithm is used for identifying, by semantic coherence, the pixels of the image which belong to a pre-existing surface 8, for example a floor (see FIG. 3), or a wall (see FIG. 4) of the room 7. A segmenting process is performed on the entire image to identify the larger surfaces, for example the walls and/or the floor. In an example embodiment, the pre-existing surface 8 may be identified by the intersection of trajectories coming from a main point of the image acquisition device 2 (which is a predetermined point, unique as a function of the acquisition device), and suggested to the user as results of the segmenting (grey area in FIGS. 3 and 4).

A classifier programmed previously, for example a Random Forest or SVM classifier, identifies and classifies the features of the pre-existing surface 8, so as to automatically identify the type of covering present on the pre-existing surface 8 and attribute a category to it. According to the results of the classification, a segmenting algorithm (that is, one or more algorithms) is selected from a series of possible algorithms designed to work on each of the surface categories identified in the identifying step. Preferably, there are at least three categories of furnishing covering surfaces.

In one particular embodiment of this invention, the intervention of the user is allowed when the result of the segmenting, obtained with a particular segmenting algorithm or a combination of algorithms, is unsatisfactory. For example, the user can indicate a characteristic point 9 on the image of the room 7; subsequently, one or more segmenting algorithms identify, by semantic coherence, the pre-existing surface 8. In one particular embodiment, the characteristic point 9 may be indicated by the user interacting with a touch-screen display 5.

The user can select, preferably using a menu displayed on the display 5, between different types of furnishing covering surface, stored in the memory 4, for replacing the pre-existing surface 8 identified previously. The user can select between different types of furnishing covering surfaces, for example tiles or parquet, selected from a database, to be superimposed on the pre-existing surface.

The display 5 displays at least one image generated by the computer 6, wherein the pre-existing surface 8 is substituted by a superimposed surface 10 of the type previously selected by the user. Preferably, the result is displayed in real time, relative to the acquisition of the image, in accordance with the lighting conditions of the room.

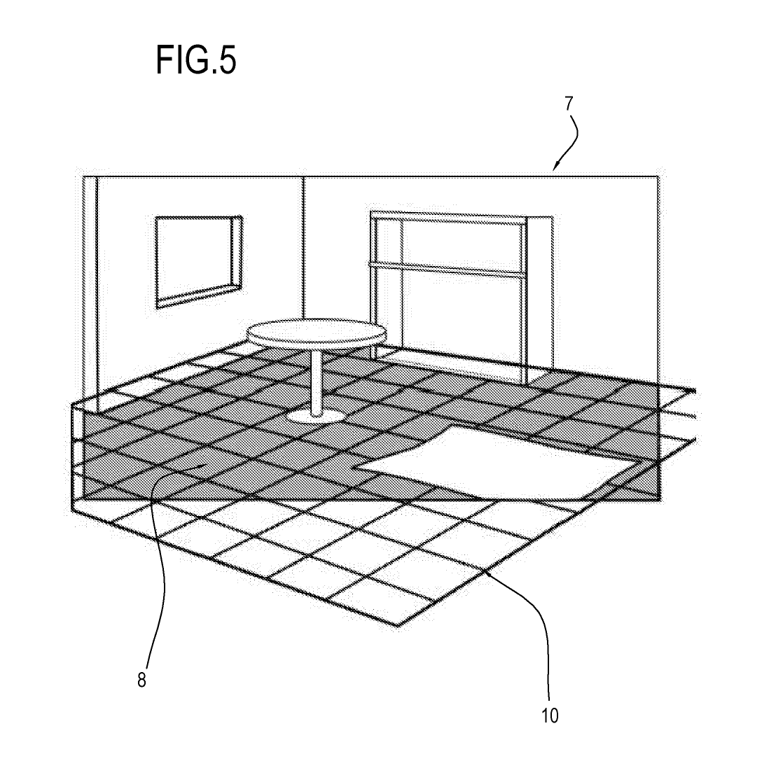

FIG. 5 shows, at the superimposed surface 10, a virtual grid (of tiles) applied on the pre-existing surface 8 (corresponding to a floor, in the example illustrated). Preferably, only (the tiles which belong to) a portion of the virtual grid (grey area in FIG. 5) is rendered graphically in the resulting image. It should be noted that the virtual grid, shown on the surface of the floor, might also be applied on any pre-existing surface 8 present in the room 7, for example a wall, in line with the orientation of the pre-existing surface 8 in the room 7.

In one particular embodiment of this invention, after the segmenting, an optional refining process is presented to the user; for example, by manual intervention, it is possible to delete segmented areas and/or select portions of images to better identify the pre-existing surface 8 and obtain a better representation of the superimposed surface 10.

This invention provides a method for helping a person to select a furnishing covering surface, comprising the following steps:
self-localizing without markers an image acquisition device 2, for determining a pose of the image acquisition device 2;
acquiring one or more images using the image acquisition device 2;
identifying, in at least one of the images acquired, a portion of image corresponding to a furnishing covering surface to be substituted;
segmenting, in one or more images acquired by the image acquisition device 2, at least said portion of image identified;
selecting, using a menu displayed on a display 5, a type of furnishing covering surface with which to replace said portion of image previously identified;
generating at least one image in which said portion of image is substituted with the type of furnishing covering surface previously selected.

Preferably, the segmenting step follows the identifying step, but not necessarily immediately after it.

Preferably, the selecting step is before the generating step, but not necessarily immediately before it.

1. A method for helping a person to select a furnishing covering surface, comprising the following steps:
self-localizing without markers an image acquisition device, for determining a pose of the image acquisition device, wherein the pose comprises position and orientation in space of the of the image acquisition device;
identifying, in at least one image acquired by the image acquisition device, of a portion of image corresponding to a pre-existing surface to be substituted;
segmenting, in one or more images acquired by the image acquisition device, at least said portion of image identified;
selecting, using a menu displayed on a display, a type of furnishing covering surface with which to replace said portion of image previously identified;
generating at least one image in which said portion of image is substituted with the type of furnishing covering surface previously selected.

2. The method according to claim 1, wherein substitution of said portion of image identified is performed by superimposing, keeping the brightness characteristics of the actual image captured.

3. The method according to claim 1, wherein the segmenting step is carried out in a two-dimensional image.

4. The method according to claim 1, wherein the segmenting step is carried out in real time relative to image acquisition.

5. The method according to claim 1, wherein the segmenting step is carried out in 3D.

6. The method according to claim 1, comprising a step of self-calibrating said image acquisition device.

7. The method according to claim 1, wherein the identifying step is carried out by means of selection, by the user, of a zone of the image acquired.

8. The method according to claim 1, comprising, between the identifying step and the segmenting step, a step of recognizing said portion of image corresponding to a pre-existing surface to be substituted, by a classifier, and a step of setting a segmenting algorithm selected from a plurality of segmenting algorithms depending on the type of furnishing covering surface detected.

9. The method according to claim 1, wherein said menu comprises a plurality of predefined types of furnishing covering surface.

10. A mobile device, equipped with an image acquisition device, a memory, a computer and a display, wherein the computer is programmed to carry out the following steps:
self-localizing without markers an image acquisition device, for determining a pose of the image acquisition device, wherein the pose comprises position and orientation in space of the image acquisition device;
identifying, in at least one image acquired by the image acquisition device, of a portion of image corresponding to a pre-existing surface to be substituted;
segmenting, in one or more images acquired by the image acquisition device, at least said portion of image identified;
selecting, using a menu displayed on a display, a type of furnishing covering surface with which to replace said portion of image previously identified;
generating at least one image in which said portion of image is substituted with the type of furnishing covering surface previously selected.

11. The mobile device according to claim 10, comprising one or more motion sensors.

12. The mobile device according to claim 10, consisting of a tablet or a smartphone, wherein the screen is a touch screen.

13. The mobile device according to claim 10, wherein the memory contains a plurality of specific segmenting algorithms for corresponding types of furnishing covering surface, and wherein the computer is programmed to run a classifier designed to assign to the furnishing covering surface, identified in an image acquired by the image acquisition device, one of said furnishing covering surface types.

14. A computer program comprising a software for carrying out the following steps:
self-localizing without markers an image acquisition device, for determining a pose of the image acquisition device, wherein the pose comprises position and orientation in space of the image acquisition device;
identifying, in at least one image acquired by the image acquisition device, of a portion of image corresponding to a pre-existing surface to be substituted;
segmenting, in one or more images acquired by the image acquisition device, at least said portion of image identified;
selecting, using a menu displayed on a display, a type of furnishing covering surface with which to replace said portion of image previously identified;
generating at least one image in which said portion of image is substituted with the type of furnishing covering surface previously selected,
if run on a device equipped with an image acquisition device, a memory, a computer and a display, wherein the computer is programmed to carry out said steps.

15. A computer readable storage medium, comprising the computer program according to claim 14.

16. Data stream representative of the computer program according to claim 14.
